(19) United States
(12) Patent Application Publication
(10) Pub. No.: US 2008/0163765 A1
(43) Pub. Date: Jul. 10, 2008

(54) APPARATUS, SYSTEM, AND METHOD FOR PRODUCING FLAVORED SMOKE ON AN OUTDOOR GRILL

(76) Inventor: Gerald M. O'Shea, Saint Paul, MN (US)

Correspondence Address: Kunzler & McKenzie, 8 EAST BROADWAY, SUITE 600, SALT LAKE CITY, UT, 84111, US

(21) Appl. No.: 11/969,771

(22) Filed: Jan. 4, 2008

Related U.S. Application Data
(60) Provisional application No. 60/883,714, filed on Jan. 5, 2007.

(51) Int. Cl. A47J 37/07; A23L 1/22; F24B 3/00

(52) U.S. Cl. 99/482; 126/25 R; 426/534

(57) ABSTRACT

An apparatus is disclosed for producing flavored smoke on an outdoor grill. The apparatus comprises a smoker that includes a container and a tortuous path. The tortuous path is devised such that certain ratios between different flow areas and volumes fall within specified ranges. Container characteristics include angled outer walls, reinforcing brace, and notched bottom. The container holds an airborne effluent source with the tortuous path enclosing the container. The tortuous path is formed through layers of non-aligned openings that allow the airborne effluent to vent from the container. The smoker may include a baffle and a raised lid cover. The raised lid cover is formed to collect undesirable wood tars.

### BACKGROUND OF THE INVENTION

1. Field of the Invention

This invention relates in general to outdoor cooking devices and more particularly relates to an apparatus for producing flavored smoke on an outdoor grill.

2. Description of the Related Art

People have long enjoyed the advantages of cooking their meats and vegetables outside over an open heat source. Searing heat traps succulent moisture into meat, slow heat enhances tenderness of meat, smoke of desirable wood varieties enhances the flavor of food, and the combination of heating and smoking can assist in the preservation of food. Furthermore, residual heat and smoke emanating from outside cooking devices are conveniently vented preventing hazard, grease, and soot from afflicting the home. Only a small number of people bear the expense and burden of using authentic open-pit barbecues, traditional brick-pit barbecues, or complex meat-smoking devices. The vast majority of people use a relatively affordable and convenient alternative such as a kettle-type charcoal grill, electric grill, or gas grill.

While gas grills in particular enjoy an enormous and growing popularity, of themselves they lack the ability to infuse the wood-smoke flavoring to foods they cook. Many gas grill users desire both the convenience and affordability of the gas grill, and the enhancement of food flavor by smoking. Producers of food products have attempted to answer the demand with chemically enhanced ‘smoke-flavored’ products. For most outdoor cooking aficionados these products have not been well-received. More promisingly, producers of outdoor grill products have answered the demand with a variety of ‘smoker boxes’ capable of being implemented in conjunction with the gas grill.

One useful type of smoker box is placed within the grill, using the heat from the grill to ignite a solid fuel contained in the smoker box such as a desirable variety of wood chip. However, these presently available smoker boxes suffer from several undesirable attributes. For example, presently available smoker boxes are formed from only two pieces: a container with a flat bottom and a lid. The simple flat bottom is ill-fitted to newer models of gas grills using ‘heat bars’ or ‘flavor bars’ and be a cooking hazard if used.

A further disadvantage of presently available smoker boxes is the inefficient and rapid consumption of fuel. Some smoker boxes are made with non-robust, thermally unsuitable material that may cause them to degrade quickly and combust their solid fuel at a high rate. Also, presently available smoker boxes with only ‘lid’ and ‘container’ can attain only relatively simple ventilation schemes causing too much air to be circulated within the smoker box, often unevenly, leading to rapid consumption of solid fuel and an added undesirable effect of producing more flame and less smoke. During the cooking process, where temperatures vary and oils may drip, the production of flame caused by more direct ventilation designs can result in flare-ups, which diminish the quality of food being cooked and are hazardous.

Additionally, the attainable ventilation schemes of available smoker boxes poorly address the presence of wood tars in the smoke. Wood tars vaporize during smoking and impart a bitter flavor to the food.

### SUMMARY OF THE INVENTION

From the foregoing discussion, it should be apparent that a need exists for an apparatus, system, and method for producing flavored smoke on an outdoor grill. Beneficially, such an apparatus, system, and method would be economical, convenient, allow a low rate of fuel consumption, produce large volumes and high densities of smoke, resist flare-ups, fit securely into a variety of outdoor grills, and reduce the presence of wood tars in the flavored smoke.

The present invention has been developed in response to the present state of the art, and in particular, in response to the problems and needs in the art that have not yet been fully solved by currently available outdoor grill accessories. Accordingly, the present invention has been developed to provide an apparatus, system, and method for producing flavored smoke on an outdoor grill that overcome many or all of the above-discussed shortcomings in the art.

An outdoor grill smoker is disclosed for producing flavored smoke on an outdoor grill. The smoker includes a container holding an airborne effluent source and a tortuous path enclosing the container that allows the airborne effluent to vent from the container through the tortuous path. The tortuous path may be formed through layers of non-aligned holes. The holes may be formed in smoker components such as a baffle and a raised lid cover. The tortuous path is devised such that certain ratios between different flow areas and volumes fall within specified ranges as described hereinafter. Container characteristics include angled outer walls to improve circulation of air, heat, and airborne effluent, a reinforcing brace, and a notched bottom designed to allow the smoker to fit into a wide range of outdoor grills.

A system is disclosed for producing flavored smoke on an outdoor grill. The system includes the outdoor grill, the smoker, and the airborne effluent source. Outdoor grills benefited from the present invention include gas grills, electric grills, and charcoal grills. The smoker may include components such as the container, the baffle, and the raised lid cover. The baffle assists in the suppression of flare-ups and the raised lid cover provides a reservoir for unwanted wood tars to condense out of the airborne effluent. Furthermore, different smoking configurations are achieved by implementing different combinations of components such as using only the raised lid cover and container together, or using only the baffle and container together. The container is designed to hold a variety of airborne effluents such as wood chips and flavored liquids.

A method is disclosed for producing flavored smoke on an outdoor grill. The method includes providing the outdoor gas grill, providing an item to be smoked, providing the smoker, and providing the airborne effluent source. The method continues by distributing the airborne effluent source into the container, enclosing the container with the baffle, covering the baffle with the raised cover, seating the smoker on a heat bar of the outdoor gas grill, igniting a burner of the gas grill, placing the item to be smoked on a rack of the gas grill, and closing a lid of the gas grill.

In one example the method continues by checking whether the item to be smoked is done and refreshing the airborne effluent as required. The method concludes by removing the smoked item when done, disengaging the burner, removing the smoker box from the gas grill, and dousing the components of the smoker in water to cool and clean. Smoker components may be equipped with grips, latches, loops, and the like to facilitate the safe removal of the smoker and the convenient disassembly of smoker components.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective drawing illustrating one embodiment of a system to produce flavored smoke on an outdoor grill in accordance with the present invention;

FIG. 2 is an illustration depicting one embodiment of a smoker to produce flavored smoke on an outdoor grill in accordance with the present invention;

FIG. 3 is an illustration depicting one embodiment of smoker flow areas and volume dimensions in accordance with the present invention; and

FIG. 4 is a schematic flow diagram depicting one embodiment of a method for smoking food on an outdoor gas grill in accordance with the present invention.

### DETAILED DESCRIPTION OF THE INVENTION

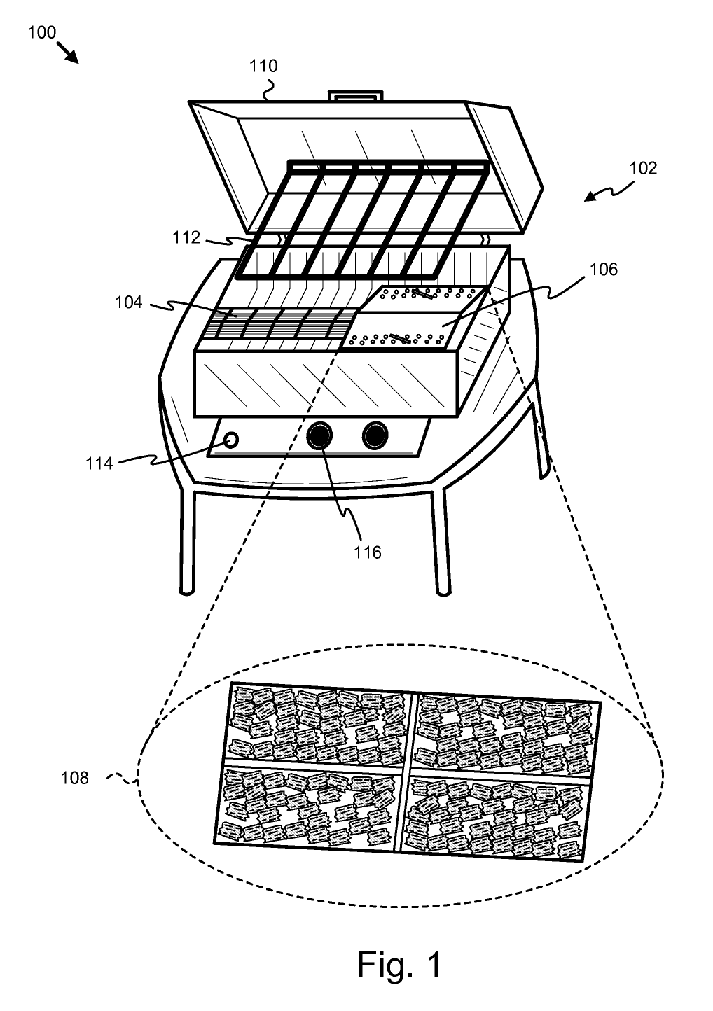

It will be readily understood that the components of the present invention, as generally described and illustrated in the figures herein, may be arranged and designed in a wide variety of different configurations. Thus, the following more detailed description of the embodiments of the apparatus, system, and method of the present invention, as presented in FIGS. 1 through 4, is not intended to limit the scope of the invention, as claimed, but is merely representative of selected embodiments of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of materials, fasteners, sizes, lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

FIG. 1 is a perspective drawing illustrating one embodiment of a system 100 to produce flavored smoke on an outdoor grill 102 in accordance with the present invention. The system 100 may comprise an outdoor gas grill 102 comprising at least one heat bar 104. In further contemplated embodiments the outdoor grill 102 may comprise one of an electric grill 102 comprising at least one heating element 104 and a charcoal grill 102. The system 100 further comprises a smoker 106 seated on the at least one heat bar 104. In one embodiment, the smoker 106 may be manufactured from stainless steel variety 304H. In other embodiments, the smoker 106 comprises at least one of the group consisting of alternate varieties and grades of stainless steel, metals, metal alloys, ceramics, and/or other materials as determined by one of skill in the art. The desirable characteristics of any material used for manufacture of the smoker 106 are heat conductivity, corrosion resistance, physical durability, and thermal durability. The smoker 106 may be molded, formed, and/or assembled with welds. Furthermore, the smoker 106 may be capable of retaining liquids during use.

The system 100 further comprises an airborne effluent source 108 disposed within the smoker 106. For example, the airborne effluent source 108 may be hickory wood chips 108 for smoking a rack of ribs. In another example desirably flavored wood chips may be soaked in water prior to use. In other embodiments considered within the scope of this invention, the airborne effluent source 108 may be a flavored liquid such as beer and the like. For example, one half of the smoker 106 may contain hickory wood chips 108, while the other half contains beer 108. The outdoor grill 102 may further comprise a lid 110 capable of trapping heat and smoke within the grill 102, a rack 112 to suspend items over the heat source 104 and smoker 106. In some embodiments the grill 102 may be equipped with an igniter 114 and a control knob 116 that may be used to control and/or extinguish heat emanating from the heat bar 104.

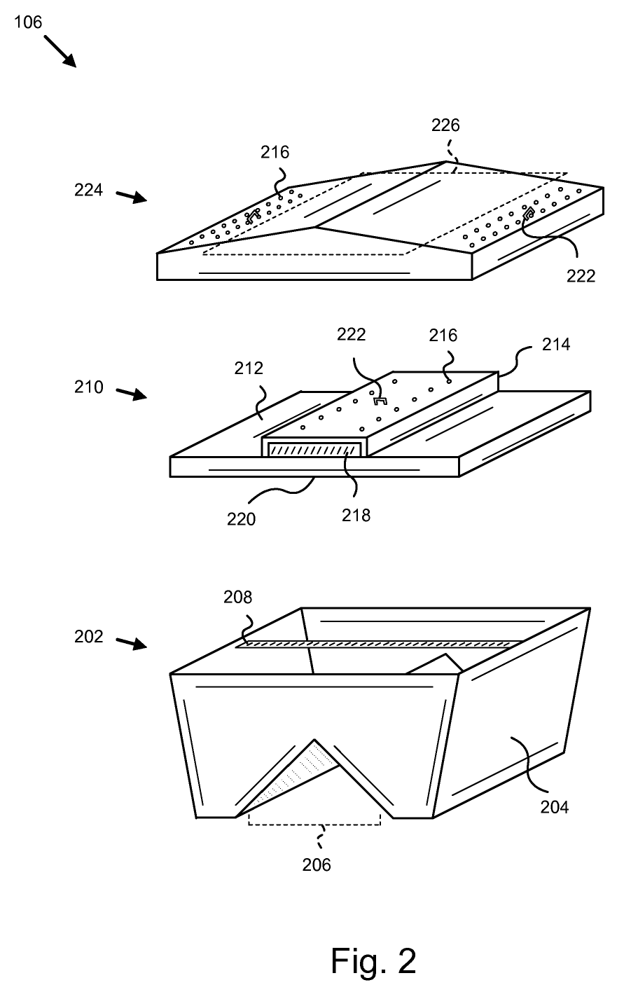

FIG. 2 is an illustration depicting one embodiment of a smoker to produce flavored smoke on an outdoor grill in accordance with the present invention. The smoker 106 comprises a container 202 holding the effluent source 108. The container 202 comprises angled outer walls 204. In one embodiment, the angled outer walls 204 may be about 10 degrees from the vertical. In alternate embodiments, the angled outer walls 204 comprise an angle between about 5 degrees and 45 degrees from the vertical. The outer walls 204 are angled for a given embodiment to improve the flow of heat and air through the container 108. The container 202 further comprises a notched bottom 206 comprising a squared angle of about 45 degrees. The notched bottom 206 is configured to straddle a heat bar 104 in the outdoor grill 102. The notched bottom 206 forms a pinnacled surface inside the container 202 running down the length of the container 202 that acts to direct the airborne effluent and heat up through the center of the smoker 106. The container 202 further comprises a reinforcing brace 208 to increase the structural rigidity and thermal durability of the container 202.

The smoker 106 may further comprise a baffle 210. The baffle 210 comprises U a baffle lid 212 that rests over the edges of the container 202 forming a partial seal. The baffle 210 further comprises a baffle plate 214 comprising a plurality of baffle holes 216 and a baffle volume 218 configured between the baffle plate 214 and the baffle lid 212. The term “holes” is used for convenience throughout the description. In alternate embodiments, the holes may be slits, screens, hatches, or other devices known in the art to provide a flow area. The lid 212 further comprises lid holes 220 (not visible) forming the bottom of and venting into the baffle volume 218. The lid holes 220 are non-aligned with the baffle holes 216 comprising a tortuous path for heat and the airborne effluent 108 flowing up through the smoker 106. The baffle plate 214 may comprise an extractor device 222 facilitating the removal of the baffle 210 from the container 202. In one embodiment, the extractor device 222 is a handle 222. In alternate embodiments, the extractor device 222 may be at least one slit, hole, loop or other device facilitating the disassembly of the smoker 106 components and usefully interface with at least one of a grill mitt, channel locks, BBQ fork, tongs, and the like.

The smoker 106 may further comprise a raised cover 224. The raised cover 224 comprises a holding volume 226 collecting the airborne effluent emanating from the baffle 210 before allowing the airborne effluent to cascade down the sloped sides of the holding volume 226 to dispersing holes 216. For example, when the airborne effluent is wood smoke the steps of collecting the smoke in the holding volume 226, allowing the smoke to cascade down the sides of the raised cover 224, and finally dispersing the smoke through the dispersing holes 216 results in a smoother, cleaner, and better tasting smoke flavor as the heavier wood tar particulates condense out of the smoke and are deposited onto the sides of the raised cover 224. The raised cover 224 may further comprise at least one extractor device 222.

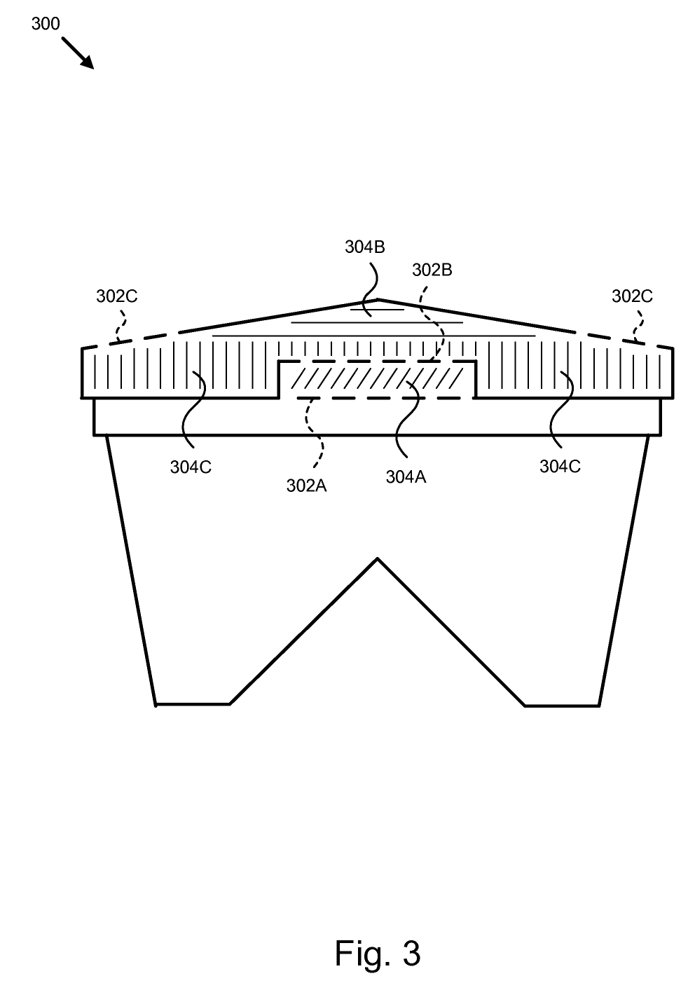

FIG. 3 is an illustration depicting one embodiment of smoker 106 flow areas 302 and volume dimensions 304 in accordance with the present invention. The smoker 106 comprises a first flow area (F₁) 302A, and a second flow area (F₂) 302B. The first flow area 302A comprises the sum of the area of the holes at the bottom of the baffle volume 304A and the second flow area 302B comprises the sum of the area of the holes at the top of the baffle volume 304A. The ratio F₁/F₂ affects the smoke quality. For example, the ratio F₁/F₂ controls the flow velocity through the various flow areas 302, affects the airborne effluent residence time in the baffle volume 304A, and interacts with the flame in the container 202. In one embodiment, the ratio of F₁/F₂ may be a value of about 1.75. In alternate embodiments, the ratio of F₁/F₂ may be a value between about 1.2 and 2.5. A value of F₁/F₂ greater than 1 indicates that the flow velocity through the flow area F₂ 302B is higher than the flow velocity through the flow area F₁ 302A.

The smoker 106 may further comprise a third flow area (F₃) 302C. The third flow area F₃ 302C comprises the sum of the flow areas at the top of the raised cover 224. The ratio F₂/F₃ affects the smoke quality. For example, the ratio F₂/F₃ controls the flow velocity through the various flow areas 302 and affects the airborne effluent residence time in the raised cover 224. The ratio F₂/F₃ may be a value of about 0.58. In other embodiments, the ratio of F₂/F₃ may be a value between about 0.2 and 0.8. A value of F₂/F₃ less than 1 indicates that the flow velocity through the flow area F₃ 302C is less than the flow velocity through the flow area F₂ 302B.

The smoker 106 further comprises a first volume (V₁) 304A. The first volume 304A comprises a volume disposed between the flow areas 302A and 302B. The ratio V₁/F₂ affects the smoke quality. For example, the ratio V₁/F₂ may determine residence times for airborne effluents and smoke densities. In one embodiment of the current invention, the ratio V₁/F₂ may be a value of about 360 mm. In alternate embodiments of the current invention, the ratio V₁/F₂ may be a value between about 90 mm and 700 mm. The larger the volume is compared to the flow area translates into a longer residence time for an airborne effluent and a higher smoke density.

The smoker 106 may further comprise a second volume (V₂) 304B. The second volume 304B comprises the volume 304B above the dispersing holes 216. The volume 304B acts as a holding volume for smoke allowing the smoke time to contact the raised cover 224 walls and leaving the heavier wood tar deposits on the wall surface. In one embodiment, the ratio of V₂/F₃ may be about 370 mm. In other embodiments, the ratio of V₂/F₃ may be between about 90 mm and 750 mm. The larger the volume is compared to the flow area translates into a longer residence time for an airborne effluent and a higher smoke density.

The smoker 106 may comprise a third volume (V₃) corresponding to volumes 304B and 304C. The third volume comprises the entire volume under the raised cover 224. In one embodiment, the ratio V₃/F₃ may be about 500 mm. In other embodiments, the ratio V₃/F₃ may be between about 125 mm and 1000 mm. The larger the volume is compared to the flow area translates into a longer residence time for an airborne effluent and a higher smoke density. Ratios of flow areas 302 and volumes 304 are meant to be illustrative of the process by which an airborne effluent flows through a tortuous path within the smoker 106. One of skill in the art may manufacture a variety of smoker 106 configurations using these values and mathematical ratios as guidelines.

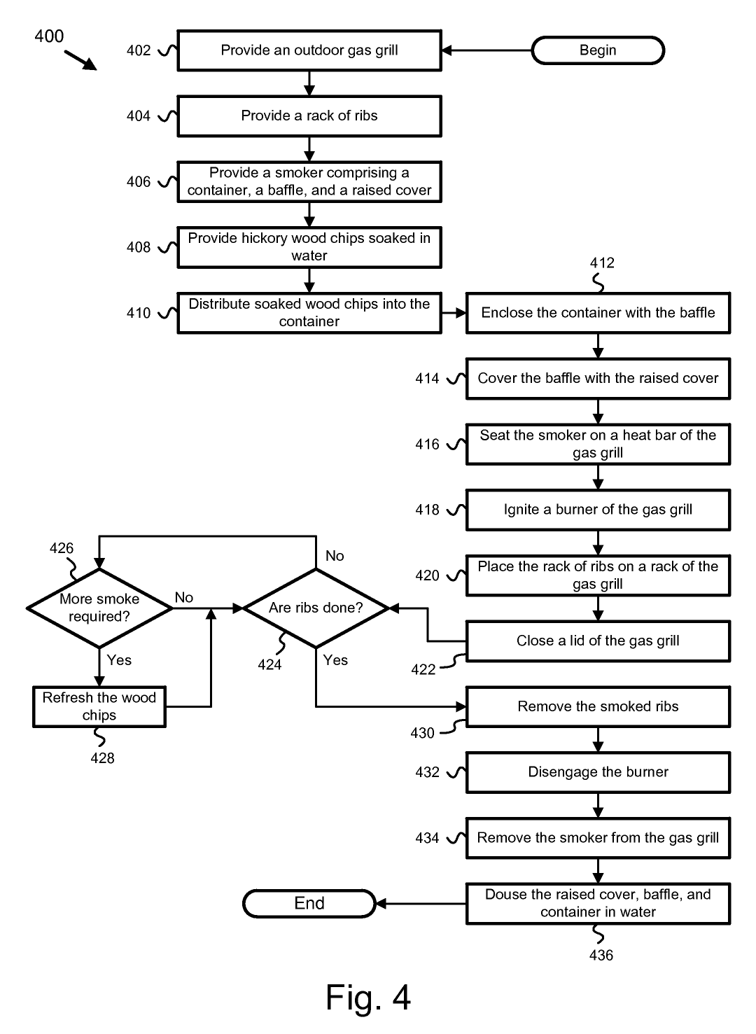

FIG. 4 is a schematic flow diagram depicting one embodiment of a method 400 for smoking food on an outdoor gas grill in accordance with the present invention. The method 400 comprises providing 402 an outdoor gas grill and providing 404 an item to be smoked. In one embodiment the method 400 includes providing 406 a smoker comprising a container, a baffle, and a raised cover. The method 400 further comprises providing 408 an airborne effluent source. In one example, providing 408 the airborne effluent comprises soaking wood chips for a time in water prior to distributing 410 the airborne effluent source into the container. Saturating wood chips with moisture causes the wood chips to smolder more slowly and facilitates a more consistent source of smoke. In one embodiment of the present invention the method 400 continues by enclosing 412 the container with the baffle, covering 414 the baffle with the raised cover, and seating 416 the smoker on a heat bar of the gas grill. In further embodiments of the present invention, alternate cooking configurations may be achieved using only the container and baffle, or only the container and raised cover.

The method 400 may further include igniting 418 at least one burner of the gas grill, placing 420 the item to be smoke on a rack of the gas grill, and closing 422 a lid of the gas grill to substantially trap the airborne effluent therein. In one example the method 400 may include checking 424 to discover if the item to be smoked is done, and checking 426 to discover if more airborne effluent is required. Should more airborne effluent be required the method 400 may include refreshing 428 the airborne effluent until the item to be smoke is done. The method 400 may conclude by removing 430 the item to be smoked, disengaging 432 the burner, removing 434 the smoker from the gas grill, and dousing 436 the raised cover, baffle, and container in water.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An outdoor grill smoker, the smoker comprising:
a container holding an airborne effluent source;
the container comprising a volume and a partial seal allowing a restricted flow of air into the volume;
a tortuous path venting the airborne effluent from the container through the tortuous path.

2. The smoker of claim 1, wherein the tortuous path comprises a plurality of non-aligned holes.

3. The smoker of claim 1, wherein the tortuous path comprises a plurality of layers.

4. The smoker of claim 3, wherein each of the plurality of layers comprises an extractor device.

5. The smoker of claim 1, wherein the tortuous path comprises a baffle.

6. The tortuous path of claim 1, the tortuous path comprising a first flow area (F₁), and a second flow area (F₂), wherein the ratio F₁/F₂ is a value between about 1.2 and about 2.5.

7. The tortuous path of claim 1, the tortuous path comprising a second flow area (F₂), and a third flow area (F₃), wherein the ratio F₂/F₃ is a value between 0.2 and 0.8.

8. The tortuous path of claim 1, the tortuous path comprising a second flow area (F₂), and a first volume (V₁), wherein the ratio V₁/F₂ is a value between about 90 mm and 700 mm.

9. The tortuous path of claim 1, the tortuous path comprising a third flow area (F₃), and a second volume (V₂), wherein the ratio of V₂/F₃ is a value between about 90 mm and 750 mm.

10. The smoker of claim 1, wherein the tortuous path comprises a raised cover comprising a holding volume and exit holes.

11. The smoker of claim 1, wherein the container comprises angled outer walls.

12. The smoker of claim 7, wherein the angled outer walls comprise an angle between about 5 and 45 degrees off the vertical plane.

13. The smoker of claim 6, wherein the angled outer walls comprise a reinforcing brace.

14. The smoker of claim 1, the container comprising a notched bottom configured to sit on a grill heat bar.

15. A method for producing flavored smoke on an outdoor grill, the method comprising:
providing an outdoor gas grill;
providing an item to be smoked;
providing a smoker comprising:
a container holding an airborne effluent source;
the container comprising a volume and a partial seal allowing a restricted flow of air into the volume;
a tortuous path venting the airborne effluent from the container through the tortuous path, the tortuous path comprising a baffle and a raised cover;
providing the airborne effluent source;
distributing the airborne effluent source into the container;
enclosing the container with the baffle;
covering the baffle with the raised cover;
seating the smoker on a heat bar of the outdoor gas grill;
igniting a burner of the gas grill;
placing the item to be smoked on a rack of the gas grill;
closing a lid of the gas grill;
removing the smoked item when done;
disengaging the burner;
removing the smoker box from the gas grill; and
dousing the raised cover, baffle, and container in water.

16. The method of claim 15, wherein providing the airborne effluent source comprises providing any combination of charcoal, wood chips, wood pellets, water, and flavored liquid.

17. The method of claim 15, wherein providing the airborne effluent comprises providing wood chips soaked in water.

18. A system for producing flavored smoke on an outdoor grill, the system comprising:
an outdoor grill;
a smoker, the smoker comprising:
a container holding an airborne effluent source;
the container comprising a volume and a partial seal allowing a restricted flow of air into the volume;
a tortuous path venting the airborne effluent from the container through the tortuous path; and
an airborne effluent source.

19. The system of claim 18, wherein the airborne effluent source comprises any combination of charcoal, wood chips, wood pellets, water, and flavored liquid.

20. The system of claim 18, wherein the outdoor grill comprises one of a gas grill, electric grill, and charcoal grill.

21. The system of claim 18, wherein the tortuous path comprises a baffle.

22. The system of claim 18, wherein the tortuous path comprises a raised cover comprising a holding volume and exit holes.

23. The system of claim 18, wherein the container comprises angled outer walls.

24. The system of claim 23, wherein the angled outer walls comprise a reinforcing brace.

25. The system of claim 18, the container comprising a notched bottom configured to sit on a grill heat bar.
